(19) United States
(12) Patent Application Publication
(10) Pub. No.: US 2014/0313691 A1
(43) Pub. Date: Oct. 23, 2014

(54) IMAGE DISPLAY DEVICE AND METHOD FOR MANUFACTURING IMAGE DISPLAY DEVICE

(71) Applicant: SHARP KABUSHIKI KAISHA, Osaka-shi (JP)

(72) Inventors: Kazuya Kaida, Osaka (JP); Koji Yamabuchi, Osaka (JP)

(73) Assignee: SHARP KABUSHIKI KAISHA, Osaka-shi (JP)

(21) Appl. No.: 14/352,316

(22) PCT Filed: Sep. 27, 2012
(86) PCT No.: PCT/JP2012/074845

§ 371 Date: Apr. 16, 2014

(30) Foreign Application Priority Data
Oct. 17, 2011 (JP) 2011-227868

(51) Int. Cl. G02F 1/1335

(52) U.S. Cl. CPC G02F 1/133504; G02F 1/133528
USPC 362/19; 362/84; 156/60; 156/285

(57) ABSTRACT

An image display device includes a light source unit emitting light, a light shutter arranged on the light source unit and selectively causing light received from the light source unit to exit therefrom, and a phosphor substrate arranged on the light shutter such that light from the light shutter enters and including a phosphor. The phosphor substrate is arranged such that the phosphor faces the light shutter. The phosphor and the light shutter are arranged to face each other with an air layer interposed therebetween.

### TECHNICAL FIELD

The present invention relates to an image display device and a method for manufacturing an image display device.

### BACKGROUND ART

Various types of image display devices equipped with a phosphor substrate have conventionally been proposed. For example, a display device described in Japanese Patent Laying-Open No. 2010-66437 includes a front face plate, a light shutter and a light source. The front face plate includes a plurality of light scatterers which produce scattered light and a planarization film formed to cover these light scatterers.

The light scatterers include a red phosphor which converts blue light into red, a green phosphor which converts blue light into green, and a blue light scatterer which scatters blue collimated light.

A liquid crystal display element is employed for the light shutter. A polarizing plate is provided as the top layer of this liquid crystal display element. The polarizing plate of the light shutter and the planarization film of the front face plate are bonded together with an adhesive.

### CITATION LIST

### Patent Document

PTD 1: Japanese Patent Laying-Open No. 2010-66437

### SUMMARY OF INVENTION

### Technical Problem

In the display device formed as described above, light from a light source enters the liquid crystal display element, and then enters the front face plate through the liquid crystal display element.

The light which enters the front face plate through the liquid crystal display element first enters an adhesive layer through the polarizing plate of the liquid crystal display element, and then the planarized layer. The light having entered the planarized layer then enters the phosphors.

Here, the difference in refractive index between the polarizing plate and the adhesive is small, and the difference in refractive index between the adhesive and the planarization film is also small.

Since light from the light source is approximately parallel light, the light exiting from the liquid crystal display element to the adhesive is approximately parallel light. Since the difference in refractive index between the adhesive and the polarizing plate is small as described above, light is hardly refracted at the interface between the polarizing plate and the adhesive.

Furthermore, since the difference in refractive index between the adhesive and the planarization film is also small, light from the light source is hardly refracted at the interface between the adhesive and the planarization film. Accordingly, light traveling through the planarization film is also approximately parallel light.

In this way, when light enters phosphors in the state of'parallel light, the light will enter the phosphors in the thickness direction of the phosphors. Since the phosphors have a small thickness, when light enters the phosphors in the thickness direction, most of the light having entered the phosphors may pass through the phosphors without being absorbed into the phosphors.

The present invention was made in view of the above-described subject, and has an object to provide an image display device in which light from a light source is prevented from passing through phosphors.

### Solution to Problem

An image display device according to the present invention includes a light source unit emitting light, a light shutter arranged on the light source unit and selectively causing light received from the light source unit to exit therefrom, and a phosphor substrate arranged on the light shutter such that light from the light shutter enters and including a phosphor. The phosphor substrate is arranged such that the phosphor faces the light shutter. The phosphor and the light shutter are arranged to face each other with an air layer interposed therebetween.

Preferably, the light shutter includes a scattering portion facing the phosphor and scattering light exiting toward the phosphor substrate. The light shutter includes a polarizing plate arranged on the opposite side of the phosphor substrate with respect to the scattering portion. The polarizing plate and the scattering portion are formed integrally.

Preferably, the phosphor substrate includes a barrier wall portion formed to surround the phosphor. The barrier wall portion is formed to protrude toward the light shutter with respect to the phosphor. The barrier wall portion is formed to be in contact with the scattering portion.

Preferably, the barrier wall portion includes a wall portion body formed to surround the phosphor and a reflection film formed to cover the wall portion body. The reflection film is formed to be in contact with the scattering portion.

Preferably, the device further includes a coupling member coupling the light shutter and the phosphor substrate. The coupling member is formed to seal the air layer, and the pressure of the air layer is a negative pressure.

Preferably, the phosphor substrate includes a transparent substrate including a first major surface and a second major surface arranged in a thickness direction, and a color filter formed on the first major surface, of the first major surface and the second major surface, that faces the light shutter. The color filter includes a plurality of filter portions arranged at a spacing from one another and a light shielding portion formed around the filter portions. A spacing between the transparent substrate and the light shutter is smaller than the spacing between the filter portions. Preferably, the phosphor substrate has formed therein a communicating channel through which the air layer communicates with the outside, and a blocking member is provided at an opening of the communicating channel.

According to another aspect, an image display device according to the present invention includes a light source unit emitting light, a light shutter arranged on the light source unit and selectively causing light received from the light source unit to exit therefrom, and a phosphor substrate arranged on the light shutter such that light from the light shutter enters and including a phosphor. The phosphor substrate is arranged such that the phosphor faces the light shutter. The light shutter includes a scattering portion facing the phosphor and scattering light exiting toward the phosphor substrate.

A method for manufacturing an image display device according to the present invention includes the steps of forming a light shutter having an exit surface from which light exits, forming a phosphor substrate with a phosphor formed therein, arranging the phosphor substrate on the light shutter such that the exit surface and the phosphor face each other, and forming a resin layer to seal an air layer between the phosphor substrate and the light shutter.

Preferably, the method further includes the step of sucking air from the air layer to the outside after forming the resin layer. Preferably, the step of forming the resin layer is performed in a negative pressure atmosphere.

Preferably, the phosphor substrate includes the phosphor and a barrier wall portion formed to surround the phosphor and protruding with respect to the phosphor. The resin layer is formed with the phosphor substrate being pressed against the light shutter such that the barrier wall portion and the light shutter are in contact with each other.

Preferably, the step of forming the light shutter includes the steps of preparing a transparent substrate, forming a polarizing plate on the transparent substrate, and performing a surface treatment on the polarizing plate to form a scattering portion on a surface of the polarizing plate. The phosphor substrate is arranged on the light shutter such that the phosphor and the scattering portion face each other.

Preferably, the step of forming the light shutter includes the steps of preparing a transparent substrate, forming a polarizing plate on the transparent substrate, and performing a coating treatment on the polarizing plate to form a scattering portion. The phosphor substrate is arranged on the light shutter such that the phosphor and the scattering portion face each other.

### Advantageous Effects of Invention

According to the image display device according to the present invention, light from a light source is prevented from passing through phosphors.

### BRIEF DESCRIPTION OF DRAWINGS

FIG. 1 is a cross-sectional view showing an image display device 1 according to the present embodiment.

FIG. 2 is a cross-sectional view showing a light shutter 3.

FIG. 3 is an enlarged cross-sectional view of part of a phosphor substrate 4 and light shutter 3.

FIG. 4 is an enlarged cross-sectional view showing an interface between a scattering portion 12 and an air layer 60.

FIG. 5 is a cross-sectional view schematically showing a green phosphor 45G, and blue light rays BL1 and BL2.

FIG. 6 is a plan view showing a lower surface 62 of green phosphor 45G.

FIG. 7 is a cross-sectional view showing a first step of a manufacturing process of phosphor substrate 4.

FIG. 8 is a cross-sectional view showing a step after the manufacturing step shown in FIG. 7.

FIG. 9 is a cross-sectional view showing a step after the manufacturing step shown in FIG. 8.

FIG. 10 is a cross-sectional view showing a step after the manufacturing step shown in FIG. 9.

FIG. 11 is a cross-sectional view showing a step after the manufacturing step shown in FIG. 10.

FIG. 12 is a cross-sectional view showing a step after the manufacturing step shown in FIG. 11.

FIG. 13 is a cross-sectional view showing a step after the manufacturing step shown in FIG. 12.

FIG. 14 is a cross-sectional view showing a step of a manufacturing process for manufacturing a counter substrate 8.

FIG. 15 is a cross-sectional view showing a step after the manufacturing step shown in FIG. 14.

FIG. 16 is a cross-sectional view showing a step after the manufacturing step shown in FIG. 15.

FIG. 17 is a cross-sectional view showing a step of assembling a light source unit 2 and light shutter 3.

FIG. 18 is a perspective view showing a shutter element 80 provided in light shutter 3 with a MEMS mechanism employed therefor.

FIG. 19 is a graph showing a luminance distribution in an image display device according to Comparative Example 1.

FIG. 20 is a graph showing a luminance distribution in image display device 1 according to the present embodiment.

FIG. 21 is a graph showing a luminance distribution in image display device 1 according to Comparative Example 2.

FIG. 22 is a cross-sectional view showing a variation of image display device 1 according to the present embodiment.

### DESCRIPTION OF EMBODIMENTS

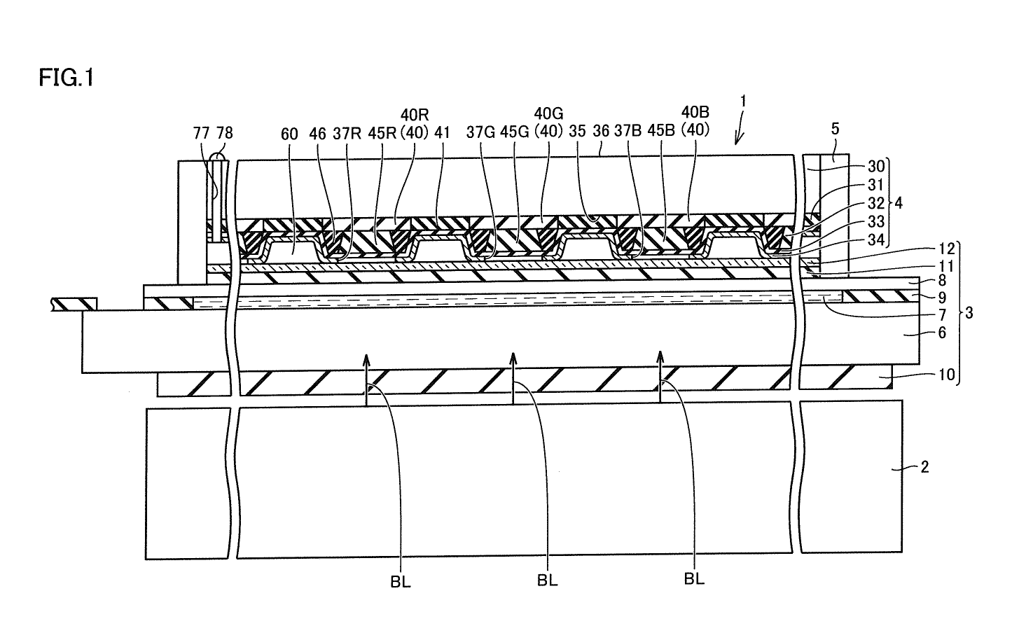

Referring to FIGS. 1 to 22, image display device 1 according to the present embodiment will be described. FIG. 1 is a cross-sectional view showing image display device 1 according to the present embodiment. In this FIG. 1, image display device 1 includes light source unit 2, light shutter 3 arranged on light source unit 2, phosphor substrate 4 arranged on light shutter 3, and a coupling member 5 which couples phosphor substrate 4 and light shutter 3.

Air layer 60 is formed between phosphor substrate 4 and light shutter 3. Phosphor substrate 4 and light shutter 3 are arranged to face each other with air layer 60 interposed therebetween. Coupling member 5 is formed to seal air layer 60. The pressure of air layer 60 is set at a negative pressure (less than or equal to the atmospheric pressure).

Coupling member 5 is over the entire circumferential surface of phosphor substrate 4, and is formed to couple phosphor substrate 4 and light shutter 3. Coupling member 5 is made of an ultraviolet hardening resin or a thermosetting resin, for example.

Light source unit 2 includes a light source, such as a plurality of LED (Light Emitting Diode) elements, and emits blue light BL toward light shutter 3. The light emitted from light source unit 2 toward light shutter 3 is approximately parallel light, and light source unit 2 is a surface emitting light source. It is noted that blue LED elements which emit blue light BL are employed for the LED elements. The LED elements are always turned on.

This blue light BL has a wavelength range more than or equal to 390 nm and less than or equal to 510 nm, for example. The wavelength when this blue light BL exhibits the highest intensity is approximately 450 nm, for example. Light shutter 3 includes a TFT substrate 6, counter substrate 8 arranged at a spacing from TFT substrate 6 and arranged to face TFT substrate 6, a liquid crystal layer 7 which fills the space between counter substrate 8 and TFT substrate 6, and a sealing member 9 which seals the space between counter substrate 8 and TFT substrate 6 with liquid crystal layer 7.

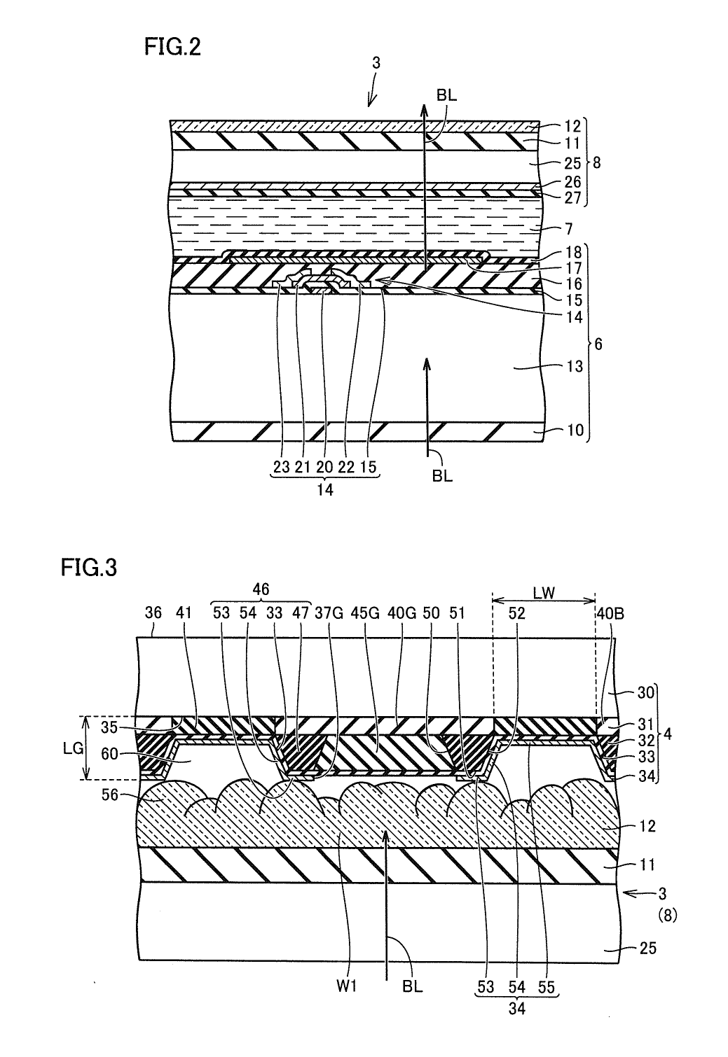

FIG. 2 is a cross-sectional view showing light shutter 3. As shown in this FIG. 2, TFT substrate 6 includes a transparent substrate 13, a TFT transistor 14 formed on a major surface of transparent substrate 13, a gate insulating film 15 formed on the major surface of transparent substrate 13, an interlayer insulating film 16 formed to cover gate insulating film 15 and TFT transistor 14, a pixel electrode 17 formed on interlayer insulating film 16, an alignment film 18 formed on interlayer insulating film 16 to cover pixel electrode 17, and a polarizing plate 10 formed on the lower surface of transparent substrate 13.

TFT transistor 14 includes a gate electrode 20 formed on the major surface of transparent substrate 13, gate insulating film 15 which covers gate electrode 20, a semiconductor layer 21 formed on gate insulating film 15, and a drain electrode 22 and a source electrode 23 formed at a spacing from each other on semiconductor layer 21. Pixel electrode 17 is connected to drain electrode 22.

A plurality of TFT transistors 14 and pixel electrodes 17 are provided. Pixel electrodes 17 are provided respectively at positions located under a red phosphor 45R, a green phosphor 45G and a scatterer 45B, which will be described later. Of the major surfaces of transparent substrate 13, polarizing plate 10 is formed on the major surface facing light source unit 2 shown in FIG. 1.

Counter substrate 8 includes a transparent substrate 25, polarizing plate 11, scattering portion 12, a counter electrode 26 formed on a major surface of the major surfaces of transparent substrate 25 that faces TFT substrate 6, and an alignment film 27 formed to cover counter electrode 26. Polarizing plate 11 is arranged on counter substrate 8 on the opposite side of light source unit 2 shown in FIG. 1. Scattering portion 12 is formed on the upper surface of polarizing plate 11. Liquid crystal layer 7 fills the space between alignment film 27 and alignment film 18. Liquid crystal layer 7 includes a plurality of liquid crystal molecules.

In FIG. 1, phosphor substrate 4 includes a transparent substrate 30 including a major surface 35 and a major surface 36 arranged in the thickness direction, a color filter 31 formed on major surface 35, of major surfaces 35 and 36, that faces light shutter 3, a phosphor layer 32 formed on one of the major surfaces of color filter 31 that faces light shutter 3, a protection film 33 formed to cover phosphor layer 32, and a reflection film 34 formed on this protection film 33.

Phosphor substrate 4 is provided with a communicating channel 77 and a blocking member 78 which blocks the opening of this communicating channel 77. Communicating channel 77 is formed to extend through transparent substrate 30, color filter 31, protection film 33, and reflection film 34, and is formed so that the outside of image display device 1 and air layer 60 communicate with each other. Blocking member 78 blocks the opening of communicating channel 77, and is removable from the opening of communicating channel 77. It is noted that air layer 60 is sealed from the outside in the state where blocking member 78 is attached. Transparent substrate 30 is formed of, for example, a glass substrate or the like.

Color filter 31 includes a plurality of filter portions 40 arranged at spacings from one another, and a black matrix 41 formed to surround each filter portion 40. Filter portion 40 includes a red filter 40R, a green filter 40G and a blue filter 40B.

Red filter 40R transmits light having a wavelength band of red light (e.g., light having a wavelength band from more than or equal to 530 nm to less than or equal to 690 nm), and absorbs light having a wavelength band other than the wavelength band of red light. Green filter 400 transmits light having a wavelength band of green light (e.g., light having a wavelength band from more than or equal to 460 nm to less than or equal to 580 nm), and absorbs light having a wavelength band other than the wavelength band of green light.

Blue filter 40B transmits light having a wavelength band of blue light (e.g., light having a wavelength band from more than or equal to 390 nm to less than or equal to 510 nm), and absorbs light having a wavelength band other than the wavelength hand of blue light. Black matrix 41 functions as a light shielding portion, and is made of for example, a carbon black-containing photosensitive resin or the like.

Phosphor layer 32 includes red phosphor 45R, green phosphor 45G, scatterer 45B, and a barrier wall portion 46 formed to cover the circumference of each phosphor and the scattering portion.

Red phosphor 45R, green phosphor 45G and scatterer 45B are arranged at spacings from one another. Red phosphor 45R is formed on the lower surface of red filter 40R, and green phosphor 45G is formed on the lower surface of green filter 40G. Scatterer 45B is formed on the lower surface of blue filter 40B.

Upon receipt of blue light BL, red phosphor 45R emits red light. It is noted that the peak wavelength where red light exhibits the highest intensity is located at and around 610 nm. The wavelength band of red light is more than or equal to 530 nm and less than or equal to 690 nm, for example.

Upon receipt of blue light BL, green phosphor 45G emits green light. The peak wavelength where green light exhibits the highest intensity is located at and around 520 nm. The wavelength band of green light is more than or equal to 460 nm and less than or equal to 580 nm, for example. Light from green phosphor 45G and red phosphor 45R is emitted radially.

Red phosphor 45R and green phosphor 45G are made of an organic fluorescent material, a nano-fluorescent material or the like. Examples of the organic fluorescent material include a rhodamine-based dye as a red phosphor dye, such as Rhodamine B, and a coumarin-based dye as a green phosphor dye, such as Coumarin 6. The nano-fluorescent material includes a binder and a plurality of phosphors scattered in the binder. The binder is made of for example, a transparent silicone-based resin, an epoxy-based resin, an acrylic resin, or the like. A nanoparticle phosphor, such as CdSe or ZnS, for example, can also be used for the phosphor. By making red phosphor 45R of a material as described above, red phosphor 45R can transmit red light (light having a wavelength band from more than or equal to 530 nm to less than or equal to 690 nm). Accordingly, light emitted by excitation of red phosphor 45R can be transmitted through red phosphor 45R itself, and use efficiency of light from red phosphor 45R can be improved.

Similarly, green phosphor 45G can transmit green light (light having a wavelength band from more than or equal to 460 nm to less than or equal to 580 nm), and use efficiency of light produced by emission of green phosphor 45G can be improved.

Scatterer 45B includes a binder and a filler scattered in the binder. Scatterer 45B may be anything that transmits or scatters blue light. As the filler, a filler having a refractive index lower than that of the binder, a filler having a refractive index higher than that of the binder, and a filler which brings about Mie scattering, such as TiO₂, can be employed. It is noted that a material having Lambertian characteristics is preferably employed as a material forming scatterer 45B.

FIG. 3 is an enlarged cross-sectional view of part of phosphor substrate 4 and light shutter 3. In this FIG. 3, barrier wall portion 46 is formed of a wall portion body 47 made of a transparent resin, a portion of protection film 33 that covers wall portion body 47, and a portion of reflection film 34 that covers barrier wall portion 46.

Wall portion body 47 includes an inner circumferential surface 50 defining regions to be filled with red phosphor 45R, green phosphor 45G and scatterer 45B, an end face 51, and an outer circumferential surface 52. It is noted that inner circumferential surface 50 and outer circumferential surface 52 are formed to hang down from the surface of color filter 31 toward light shutter 3. End face 51 is formed to connect inner circumferential surface 50 and outer circumferential surface 52.

It is noted that, of the surfaces of red phosphor 45R, green phosphor 45G and scatterer 45B, portions facing light shutter 3 are formed to be uncovered by wall portion body 47.

Protection film 33 is made of a transparent insulating film of, for example, SiO₂, SiN or the like. Protection film 33 is formed to cover green phosphor 45G and wall portion body 47.

Reflection film 34 is formed of a metal film of for example, aluminum, silver, an alloy material of aluminum and silver, or the like. Reflection film 34 includes an end face section 53 formed on end face 51 of wall portion body 47, an inclined section 54 connected to end face section 53 and formed on outer circumferential surface 52 of wall portion body 47, and a flat section 55 formed at a portion located between wall portion bodies 47.

Reflection film 34 has an opening 37G formed therein. Because of this opening 37G, a portion of the surface of green phosphor 45G that faces light shutter 3 is a plane of incidence where blue light BL can enter. It is noted that, as shown in FIG. 1, reflection film 34 has an opening 37R and an opening 37B formed therein. Because of opening 37R, a portion of the surface of red phosphor 45R that faces light shutter 3 is a plane of incidence where blue light BL enters. Because of opening 37B, a portion of the surface of scatterer 45B that faces light shutter 3 is a plane of incidence where blue light BL can enter.

In FIG. 3, barrier wall portion 46 includes wall portion body 47, protection film 33, end face section 53, and inclined section 54. Barrier wall portion 46 is formed to protrude toward light shutter 3 with respect to green phosphor 45G.

Of the surfaces of scattering portion 12, a plurality of particulates 56 are formed in a surface that faces phosphor substrate 4. End face section 53 of barrier wall portion 46 and particulates 56 of scattering portion 12 are arranged to be in contact with each other. Since the pressure of air layer 60 is set at a negative pressure, light shutter 3 and phosphor substrate 4 are biased to approach each other, and the contact between reflection film 34 and end face section 53 is maintained in a favorable state.

It is noted that, when the pressure of air layer 60 increases, blocking member 78 shown in FIG. 1 is removed, and then air between phosphor substrate 4 and light shutter 3 is exhausted through communicating channel 77. The negative pressure state of air layer 60 can thereby be restored.

Since end face section 53 is formed on the lower surface of protection film 33, end face section 53 of barrier wall portion 46 is mainly in contact with particulates 56, and protection film 33 and particulates 56 are hardly in contact with each other. Accordingly, air layer 60 is created between green phosphor 45G and scattering portion 12. It is noted that the case were scattering portion 12 and protection film 33 formed on the lower surface of green phosphor 45G are completely spaced from each other is not a limitation, but the leading ends of particulates 56 of scattering portion 12 and part of protection film 33 formed on the lower surface of green phosphor 45G may be in contact with each other.

A distance LG between major surface 35 of transparent substrate 30 and scattering portion 12 is smaller than a distance LW between blue filter 40B and green filter 40G.

The operation of thus configured image display device 1 will be described. For example, the case where blue light BL enters green phosphor 45G to cause green phosphor 45G to emit light will be described. In FIG. 1, blue light BL is emitted from light source unit 2 into light shutter 3.

In FIG. 2, blue light BL having entered light shutter 3 passes through polarizing plate 10 and TFT substrate 6. On this occasion, TFT transistor 14 connected to pixel electrode 17 located under green phosphor 45G is on, and a predetermined voltage is applied to pixel electrode 17 located under green phosphor 45G. Among liquid crystal molecules in liquid crystal layer 7, the sequence of liquid crystal molecules located between above-described pixel electrode 17 and counter electrode 26 is changed.

Blue light BL then passes through above-described pixel electrode 17, alignment film 18 and counter substrate 8, and further through polarizing plate 11. Blue light BL having passed through polarizing plate 11 enters scattering portion 12.

It is noted that when causing green phosphor 45G to emit light, light shutter 3 controls blue light BL such that blue light BL does not enter scatterer 45B and scatterer 45B adjacent to this green phosphor 45G.

Specifically, light shutter 3 does not apply a voltage to pixel electrode 17 located under red phosphor 45R and scatterer 45B. Accordingly, blue light BL emitted from light source unit 2 toward red phosphor 45R and scatterer 45B is shielded by polarizing plate 11. Accordingly, when causing green phosphor 45G to emit light, red phosphor 45R adjacent to that green phosphor 45G is prevented from emitting light, and scatterer 45B adjacent to above-described green phosphor 45G is prevented from emitting blue light BL.

Therefore, in FIG. 3, blue light BL enters a portion of scattering portion 12 that is located under green filter 400.

FIG. 4 is an enlarged cross-sectional view showing an interface between scattering portion 12 and air layer 60. In the example shown in this FIG. 4 and the like, polarizing plate 11 is formed integrally with scattering portion 12. Specifically, scattering portion 12 is formed by subjecting the surface of polarizing plate 11 to a surface treatment by sandblast or using a chemical. Accordingly, plurality of particulates 56 are formed on the surface of scattering portion 12, and a plurality of uneven portions are formed on the surface of scattering portion 12. Particulates 56 have a size of approximately more than or equal to 1 μm and less than or equal to 10 μm. Since polarizing plate 11 and scattering portion 12 are integral, “wrinkles” or “undulations” are prevented from occurring in scattering portion 12.

It is noted that it is not essential to form polarizing plate 11 and scattering portion 12 integrally, but scattering portion 12 may be formed on the surface of polarizing plate 11 by applying a chemical liquid containing fine powders, such as silica, on the surface of polarizing plate 11 and performing a baking treatment. In this way, when carrying out a coating treatment on the surface of polarizing plate 11, polarizing plate 11 and scattering portion 12 will be separate members. Also in this example, a plurality of uneven portions can be formed at the surface of scattering portion 12.

In the example shown in this FIG. 4, blue light rays BL1 and BL2 enter a particulate 56a, and a blue light ray BL3 enters a particulate 56b. It is noted that in the state before exiting from scattering portion 12, blue light rays BL1, BL2 and BL3 are approximately parallel to one another.

Blue light ray BL1 enters a surface 61a of particulate 56a perpendicularly to surface 61a. Blue light ray BL1 thus exits from surface 61a to air layer 60 without being refracted at the interface between surface 61a and air layer 60.

Blue light ray BL2 enters surface 61 a such that the incident angle with respect to surface 61a is an incident angle θ1. Blue light ray BL3 enters a surface 61b such that the incident angle with respect to surface 61b of particulate 56b is an incident angle θ3.

Since the refractive index of scattering portion 12 is larger than that of air layer 60, a refraction angle θ2 of blue light ray BL2 is larger than incident angle θ1, and further, a refraction angle θ4 of blue light ray BL3 is larger than incident angle θ3. Since particulates 56a and 56b differ in shape from each other, and blue light rays BL2 and BL3 completely differ in incident position from each other, blue light rays BL2 and BL3 travel in completely different directions. Accordingly, blue light rays BL1, BL2 and BL3 which have been parallel light are scattered at scattering portion 12.

In the present embodiment, air layer 60 is located on the surface of scattering portion 12, and the refractive index of air layer 60 is 1.0. Therefore, blue light BL is greatly refracted at the surface of scattering portion 12. For instance, as a comparative example, assume that a resin layer is provided instead of air layer 60. The difference in refractive index between the resin layer and scattering portion 12 will be smaller than the difference in refractive index between air layer 60 and scattering portion 12. Therefore, scattering of blue light BL at the surface of scattering portion 12 will be greater in image display device 1 according to the present embodiment than in an image display device of the comparative example.

In this way, since blue light BL is scattered favorably at the surface of scattering portion 12, blue light BL enters green phosphor 45G at various incident angles with respect to green phosphor 45G.

In other words, scattering of blue light BL reduces blue light rays traveling through green phosphor 45G in the thickness direction of green phosphor 45G, such as blue light ray BL1, and increases blue light rays BL entering at an inclination with respect to green phosphor 45G.

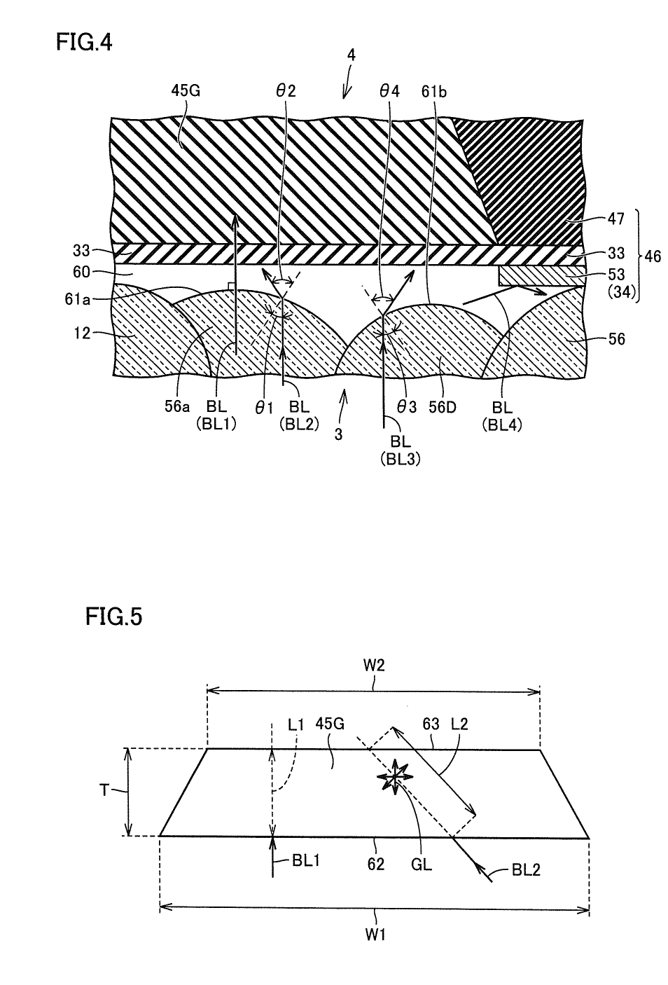

FIG. 5 is a cross-sectional view schematically showing green phosphor 45G, and blue light rays BL1 and BL2. Here, assume that a path length along which light traveling in the thickness direction of green phosphor 45G, such as blue light ray BL1, passes through green phosphor 45G after entering lower surface 62 of green phosphor 45G and before exiting from an upper surface 63 is a path length L1. Assume that a path length along which light entering green phosphor 45G at an inclination, such as blue light ray BL2, passes through green phosphor 45G after entering lower surface 62 and before exiting from upper surface 63 is a path length L2.

Comparing path lengths L1 and L2, path length L2 is longer than path length L1 as is clearly seen from FIG. 5.

If the path length along which blue light BL passes through green phosphor 45G is long, the light is likely to be absorbed into green phosphor 45G, and blue light BL is unlikely to pass through green phosphor 45G. If blue light ray BL2 is absorbed into green phosphor 45G, a radial green light ray GL will be emitted within green phosphor 45G.

As a result, scattering of blue light BL as shown in FIG. 4 can reduce blue light BL passing through green phosphor 45G, and an observer can observe clear green light from green phosphor 45G.

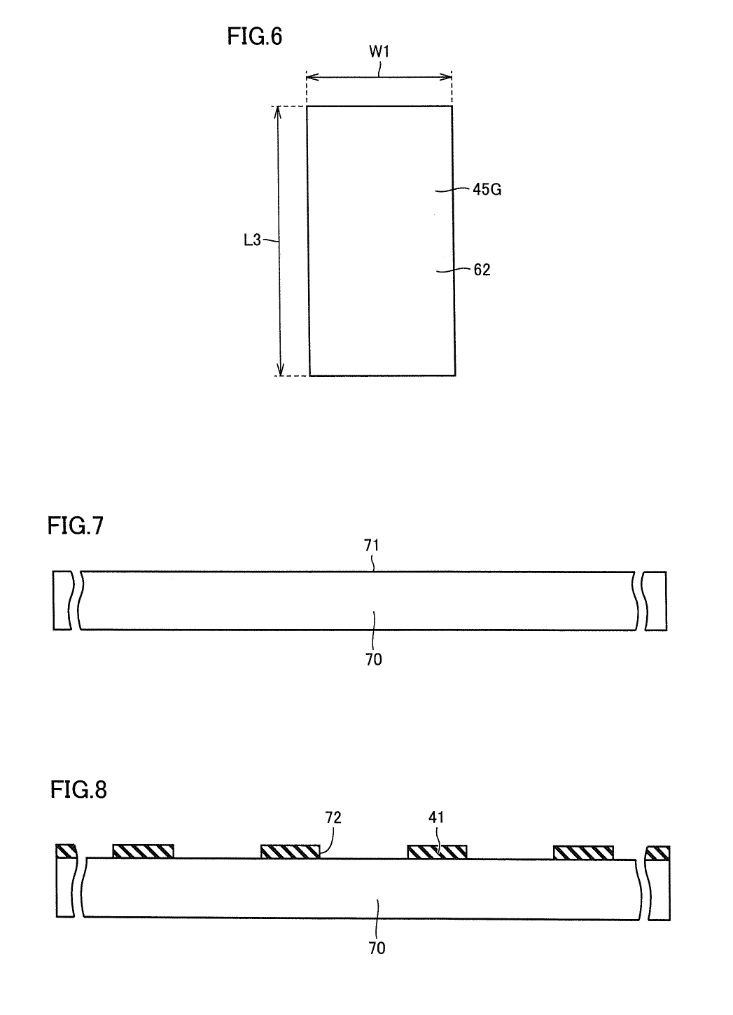

In FIG. 5, green phosphor 45G is formed to have a width decreasing from lower surface 62 to upper surface 63. A width W1 of lower surface 62 of green phosphor 45G is larger than a thickness T of green phosphor 45G, and a width W2 of upper surface 63 is also larger than thickness T. FIG. 6 is a plan view showing lower surface 62 of green phosphor 45G. As shown in FIG. 6, lower surface 62 of green phosphor 45G is formed to have an approximately rectangular shape. A length L3 of lower surface 62 in the longitudinal direction is formed to be larger than width W1. It is noted that FIG. 6 shows an example shape of green phosphor 45G.

Since blue light BL from scattering portion 12 travels in various directions as shown in FIG. 4, part of blue light BL exiting from scattering portion 12, such as a blue light ray BL4, may travel toward scatterer 45B or red phosphor 45R.

Barrier wall portion 46 surrounding green phosphor 45G is in contact with scattering portion 12, and prevents blue light ray BL4 from traveling toward scatterer 45B or the like. Accordingly, when causing green phosphor 45G to emit light, blue light BL can be prevented from exiting from scatterer 45B toward the outside. Similarly, when causing green phosphor 45G to emit light, blue light BL can be prevented from entering red phosphor 45R to cause red phosphor 45R to emit light.

Particularly since end face section 53 of reflection film 34 is formed at the bottom end of barrier wall portion 46, light such as blue light ray BL4 can be reflected, and when causing green phosphor 45G to emit light, blue light BL can be prevented from entering red phosphor 45R and scatterer 45B.

Furthermore, the distance in the height direction between the lower surface of green phosphor 45G and the bottom end of barrier wall portion 46 is approximately the thickness of protection film 33 and reflection film 34. Since green phosphor 45G and scattering portion 12 are close to each other in this way, a large part of blue light BL exiting from scattering portion 12 enters green phosphor 45G.

It is noted that, by blue light BL entering green phosphor 45G, radial green light rays GL are produced in green phosphor 45G. Of these green light rays GL emitted radially, a green light ray GL traveling toward green filter 40G directly exits to the outside. On the other hand, green light rays GL emitted in the transverse direction and the like are reflected toward green filter 40G by reflection film 34 shown in FIG. 3. Improvement in use efficiency of light is thereby achieved.

Polarizing plate 11 and scattering portion 12 are formed integrally, and “wrinkles” or “undulations” are prevented from occurring in scattering portion 12. This can ensure that polarizing plate 11 and barrier wall portion 46 are in contact with each other. Furthermore, space can be prevented from being left between polarizing plate 11 and scattering portion 12, and image display device 1 can be reduced in thickness as a whole.

For example, the total of the thickness of transparent substrate 25, the thickness of polarizing plate 11 and the thickness of scattering portion 12 is set at approximately 300 mm, for example. Furthermore, distance LG between major surface 35 of transparent substrate 30 and scattering portion 12 is smaller than distance LW between blue filter 40B and green filter 40G, and reduction in profile of image display device 1 is achieved.

it is noted that, although the example where scattering portion 12 is formed has been described in the present embodiment, scattering portion 12 is not always an essential feature.

For example, even when scattering portion 12 is not formed on the upper surface of polarizing plate 11, slight unevenness is formed at the surface of polarizing plate 11. Therefore, by arranging light shutter 3 and phosphor substrate 4 to face each other with air layer 60 interposed therebetween, blue light BL is greatly refracted at the interface between polarizing plate 11 and air layer 60 when exiting from polarizing plate 11.

Accordingly, blue light rays BL that enter green phosphor 45G perpendicularly can be reduced, while blue light rays BL that enter green phosphor 45G at an inclination can be increased.

While the above description has been given with reference to FIGS. 3 to 6 focusing attention on green phosphor 45G, a similar effect can also be obtained in red phosphor 45R and scatterer 45B shown in FIG. 1.

Specifically, blue light BL enters red phosphor 45R from scattering portion 12 in various directions. Accordingly, also in red phosphor 45R, blue light BL can be prevented from passing through red phosphor 45R. Moreover, also in scatterer 45B, blue light BL can be prevented from passing through scatterer 45B with high directivity.

Furthermore, when selectively causing red phosphor 45R to emit light, blue light BL can be prevented from entering scatterer 45B or green phosphor 45G located around this red phosphor 45R. Similarly, when selectively causing blue light BL to exit from scatterer 45B, blue light BL can be prevented from entering green phosphor 45G and red phosphor 45R.

A method for manufacturing image display device I formed as described above will be described. Image display device 1 according to the present embodiment is manufactured as follows: for example, light source unit 2, light shutter 3 and phosphor substrate 4 are independently manufactured by different manufacturing processes, and then, light source unit 2, light shutter 3 and phosphor substrate 4 are assembled to each other to manufacture image display device 1.

First, the manufacturing process of phosphor substrate 4 will be described. FIG. 7 is a cross-sectional view showing a first step of the manufacturing process of phosphor substrate 4. As shown in this FIG. 7, a mother glass substrate 70 having a major surface 71 is prepared.

FIG. 8 is a cross-sectional view showing a step after the manufacturing step shown in FIG. 7. In this FIG. 8, a carbon black-containing photosensitive resin or the like is formed on major surface 71 of mother glass substrate 70 by a spin coat method or the like.

Thereafter, this resin layer is subjected to a heat treatment. Then, this resin layer is subjected to an exposure treatment using a mask. After development processing, the resin layer is subjected to a baking treatment to form black matrix 41. Black matrix 41 is formed in a lattice, for example, and black matrix 41 has a hole 72 formed therein.

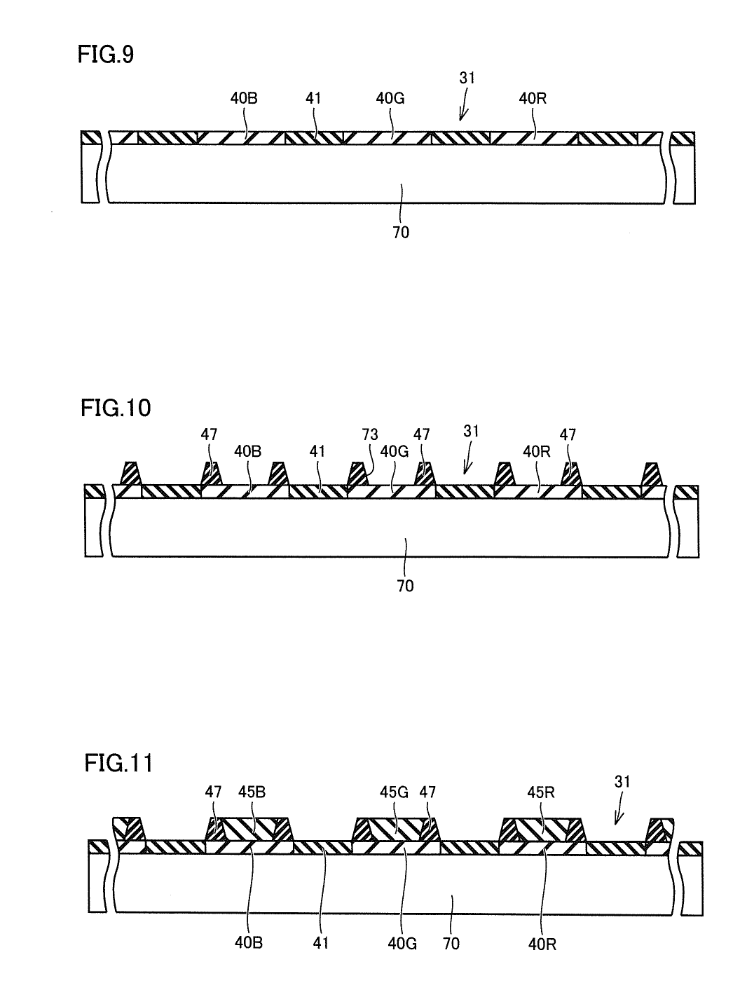

FIG. 9 is a cross-sectional view showing a step after the manufacturing step shown in FIG. 8. In this FIG. 9, each hole 72 of black matrix 41 is filled with a filter material of each color by an ink jet method. Then, the filter material is subjected to a baking treatment, thereby forming blue filter 40B, green filter 40G and red filter 40R.

FIG. 10 is a cross-sectional view showing a step after the manufacturing step shown in FIG. 9. In this FIG. 9, first, a positive resist is applied to color filter 31. Then, this positive resist is subjected to photolithography to form transparent wall portion body 47. Wall portion body 47 is formed in the shape of a frame, and a plurality of holes 73 are formed in this barrier wall portion 46.

FIG. 11 is a cross-sectional view showing a step after the manufacturing step shown in FIG. 10. In this FIG. 11, a scattering material, a green phosphor liquid and a blue phosphor liquid are sprayed into each hole 73 with an ink jet device. Then, the scattering material, the green phosphor liquid and the blue phosphor liquid are subjected to a baking treatment to form scatterer 45B, green phosphor 45G and red phosphor 45R.

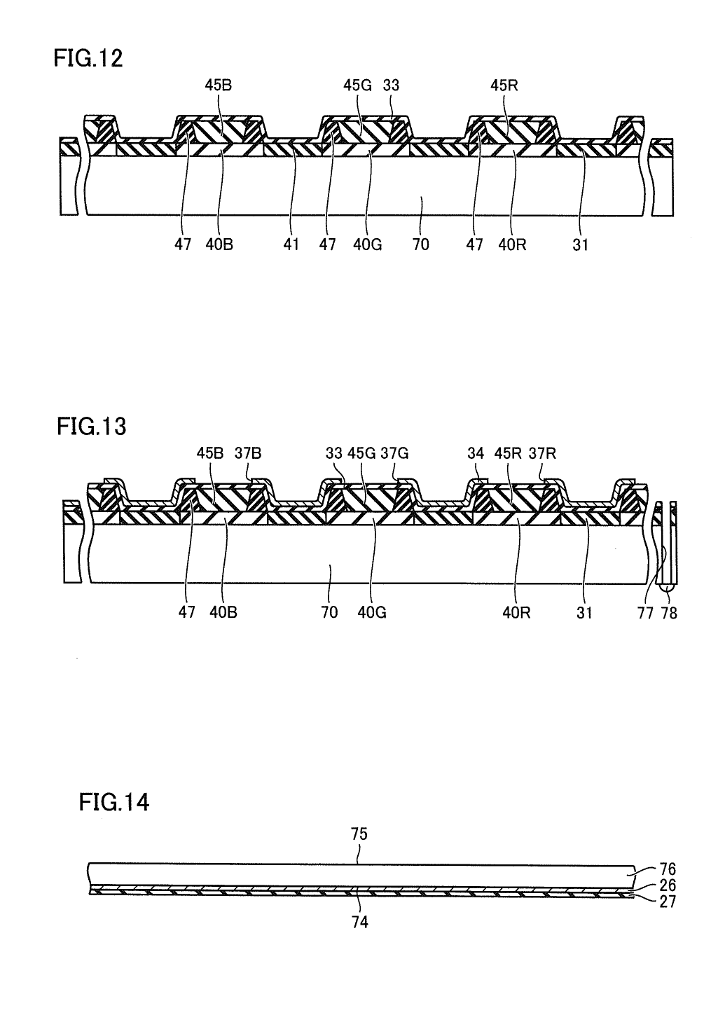

FIG. 12 is a cross-sectional view showing a step after the manufacturing step shown in FIG. 11. As shown in this FIG. 12, protection film 33 is formed on the upper surface of color filter 31 to cover scatterer 45B, green phosphor 45G red phosphor 45R, and wall portion body 47.

FIG. 13 is a cross-sectional view showing a step after the manufacturing step shown in FIG. 12. As shown in this FIG. 13, a metal film of aluminum, silver, an alloy thereof, or the like is formed by sputtering or the like on the upper surface of protection film 33. Thereafter, this metal film is patterned to form opening 37B, opening 37G and opening 37R. In this manner, reflection film 34 is formed. It is noted that, when patterning the metal film, scatterer 45B, green phosphor 45G and red phosphor 45R can be prevented from deteriorating since protection film 33 is formed on the upper surface of scatterer 45B, green phosphor 45G and red phosphor 45R. Communicating channel 77 and blocking member 78 are formed.

By cutting mother glass substrate 70 with color filter 31, scatterer 45B, green phosphor 45G, red phosphor 45R, and the like formed thereon, a plurality of phosphor substrates 4 can be manufactured.

Next, a method for manufacturing counter substrate 8 will be described with reference to FIGS. 14 to 16. FIG. 14 is a cross-sectional view showing a step of a manufacturing process of manufacturing counter substrate 8. In this FIG. 14, first, a mother transparent substrate 76 including major surfaces 74 and 75 arranged in the thickness direction is prepared. Thereafter, a transparent conducting film, such as an ITO (Indium Tin Oxide) film, is formed on major surface 74 of transparent substrate 25. Thereafter, this transparent conducting film is patterned to form counter electrode 26.

Thereafter, a polyimide film is formed to cover this counter electrode 26. Thereafter, this polyimide film is subjected to a rubbing treatment to form alignment film 27.

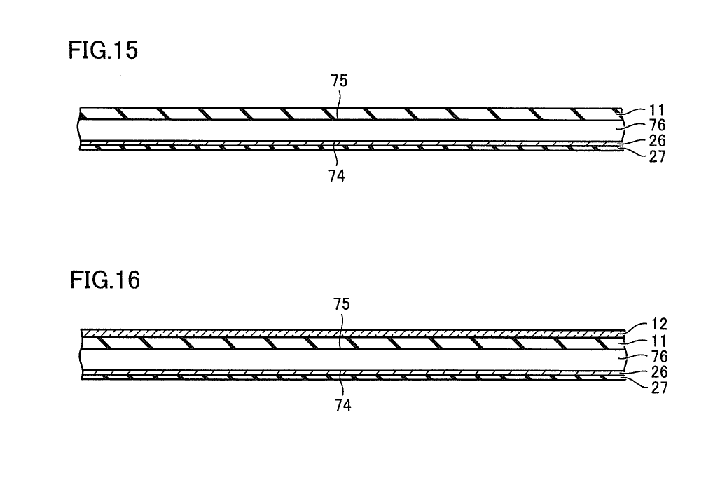

FIG. 15 is a cross-sectional view showing a step after the manufacturing step shown in FIG. 14. As shown in this FIG. 15, polarizing plate 11 is formed on major surface 75 of mother transparent substrate 76.

FIG. 16 is a cross-sectional view showing a step after the manufacturing step shown in FIG. 15. In the step shown in this FIG. 16, scattering portion 12 is formed on the upper surface of polarizing plate 11. Examples of the method for forming scattering portion 1.2 mainly include two techniques.

A first technique for forming scattering portion 12 will be described first. In the first technique, the surface of polarizing plate 11 as formed is subjected to a surface treatment by sandblast or using a chemical. Crimps are thereby formed at the surface of polarizing plate 11. Scattering portion 12 is thus formed on the upper surface of polarizing plate 11. It is noted that, with this first technique, scattering portion 12 and polarizing plate 11 are formed integrally.

With the second technique for forming scattering portion 12, a chemical liquid containing fine powders, such as silica, is applied to the surface of polarizing plate 11. Thereafter, this chemical liquid is subjected to a baking treatment to form scattering portion 12 on the surface of polarizing plate 11. In this way, with the second technique for performing a coating treatment on the surface of polarizing plate 11, polarizing plate 11 and scattering portion 12 will be separate members. By cutting mother transparent substrate 76 with scattering portion 12 formed thereon, a plurality of counter substrates 8 can be formed.

It is noted that, in the manufacturing method shown in FIGS. 14 to 16, polarizing plate 11 and scattering portion 12 are formed after forming counter electrode 26 and alignment film 27, however, counter electrode 26 and alignment film 27 may be formed after forming polarizing plate 11 and scattering portion 12. It is noted that TFT substrate 6 shown in FIG. 1 can be manufactured by a publicly-known manufacturing method.

TFT substrate 6 and counter substrate 8 are bonded together, and liquid crystal layer 7 fills the space between TFT substrate 6 and counter substrate 8, so that light shutter 3 can be manufactured.

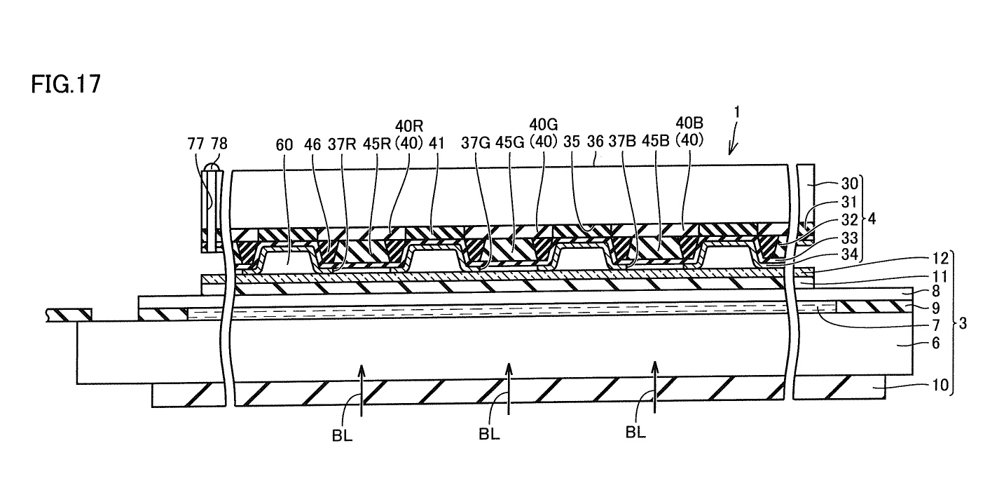

Next, a step of assembling light source unit 2 and light shutter 3 will be described with reference to FIG. 17.

First, light shutter 3 and phosphor substrate 4 are arranged such that scatterer 45B, green phosphor 45G and red phosphor 45R in phosphor substrate 4 face scattering portion 12 of light shutter 3 to one another.

On this occasion, phosphor substrate 4 is pressed against light shutter 3 from above phosphor substrate 4. With phosphor substrate 4 being pressed against light shutter 3, a resin portion is formed along the outer circumference of phosphor substrate 4.

For example, a thermosetting resin, an ultraviolet hardening resin or the like can be employed for this resin portion. It is noted that a material having high viscosity is selected as the material of the resin portion. By selecting that material, the resin portion is easily formed along the outer circumference of phosphor substrate 4, and further, the resin portion can be formed over phosphor substrate 4 and light shutter 3. Then, coupling member 5 shown in FIG. 1 can be formed by hardening this resin portion.

Coupling member 5 is over the entire circumferential surface of phosphor substrate 4, and the space between phosphor substrate 4 and light shutter 3 is sealed.

Thereafter, blocking member 78 is removed to exhaust air between phosphor substrate 4 and light shutter 3 through communicating channel 77. In this manner, air layer 60 can be brought into a negative pressure state.

It is noted that, as a method for forming air layer 60 in a negative pressure state, for example, air layer 60 can be brought into a negative pressure state by carrying out the step of bonding phosphor substrate 4 and light shutter 3 in a negative pressure atmosphere.

Although the example where a liquid crystal device is employed as light shutter 3 has been described in the present embodiment, light shutter 3 with a MEMS (Micro Electro Mechanical Systems) mechanism employed therefor can be employed as light source unit 2 and light shutter 3.

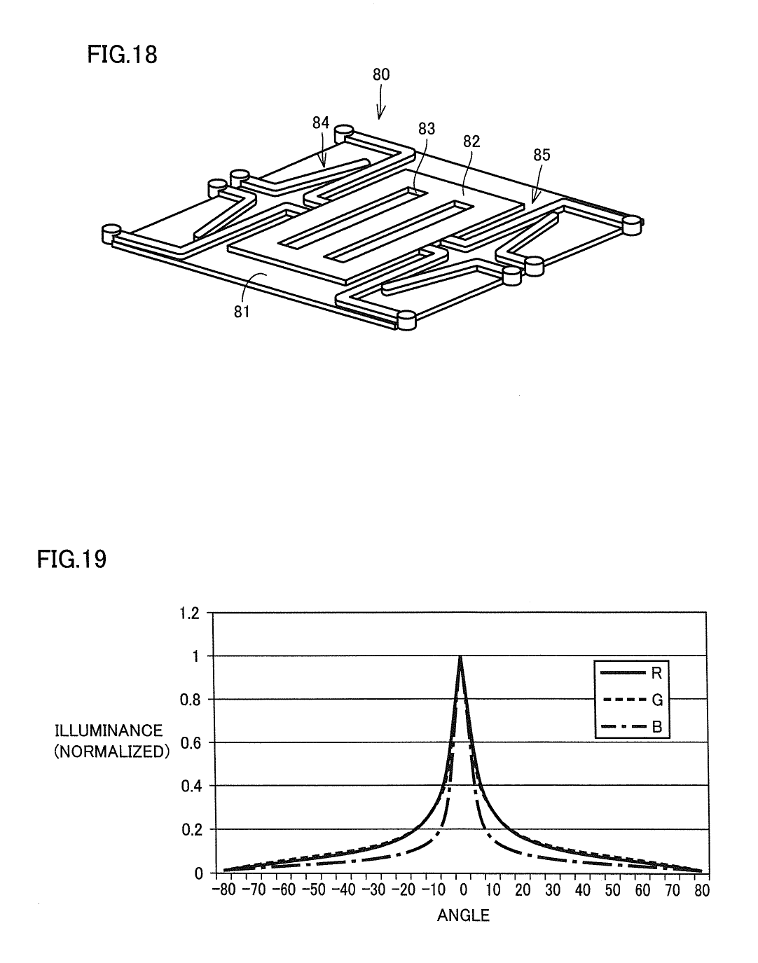

FIG. 18 is a perspective view showing shutter element 80 provided for light shutter 3 with the MEMS mechanism employed therefor. It is noted that shutter element 80 is provided for each of green phosphor 45G, red phosphor 45R and scatterer 45B. Light shutter 3 with the MEMS mechanism employed therefor includes scattering portion 12 on this shutter element 80, and barrier wall portion 46 is in contact with scattering portion 12.

Shutter element 80 includes a reflecting plate 81 having an opening formed therein, a shutter plate 82 provided on reflecting plate 81 and having an opening 83 formed therein, and actuators 84 and 85 for slidingly moving shutter plate 82. Shutter plate 82 is driven in a time division manner.

When shutter plate 82 is moved so that the opening of reflecting plate 81 and the opening 83 of shutter plate 82 communicate with each other, blue light BL from light source unit 2 enters corresponding green phosphor 45G, red phosphor 45R or scatterer 45B.

The light shutter with the MEMS mechanism employed therefor is not provided with a polarizing plate, and improvement in use efficiency of light from light source unit 2 can be achieved.

Furthermore, since the response speed of shutter plate 82 is high and less affected by the ambient temperature, an image can be displayed favorably.

It is noted that, in the case of achieving improvement in use efficiency of blue light BL having passed through the light shutter with the MEMS mechanism employed therefor, shutter plate 82 and phosphor substrate 4 are arranged close to each other.

Here, illumination distributions of various image display devices 1 are compared with reference to FIGS. 19 to 21.

It is noted that, in the graphs shown in FIGS. 19 to 21, the horizontal axis indicates the angle at which light is radiated, and the vertical axis indicates the luminance. It is noted that the luminance on the vertical axis is normalized, and the luminance with the highest illuminance is assumed to be “1”.

The solid line in each graph indicates the luminance distribution when a red filter is observed in each image display device. The broken line indicates the luminance distribution when a green filter is observed. The alternate long and short dash line indicates the luminance distribution when a blue filter is observed.

FIG. 19 is a graph showing the luminance distribution in an image display device according to a Comparative Example 1. The image display device according to this comparative example is image display device 1 shown in FIG. 1 from which scattering portion 12 has been omitted.

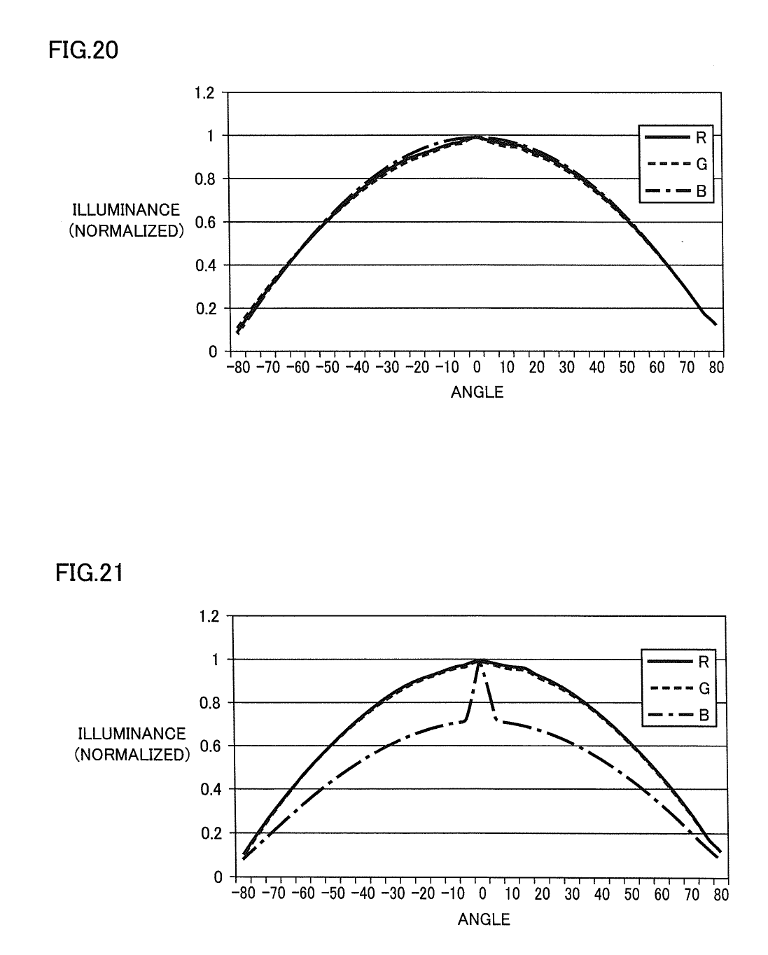

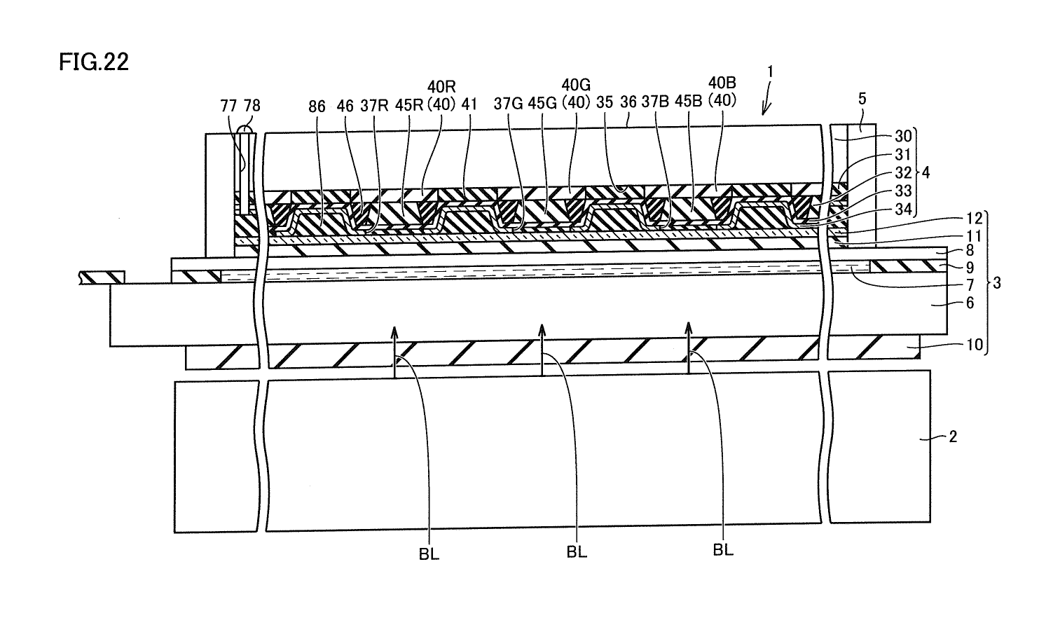

FIG. 20 is a graph showing the luminance distribution in image display device 1 shown in FIG. 1. FIG. 21 is a graph showing the luminance distribution of image display device 1 shown in FIG. 22. FIG. 22 is a cross-sectional view showing a variation of image display device 1 according to the present embodiment. In the example shown in this FIG. 22, a resin layer 86 fills the space between light shutter 3 and phosphor substrate 4 instead of air layer 60 shown in FIG. 1. In this example shown in FIG. 22, blue light BL is scattered favorably by scattering portion 12.

Here, as is clear from FIG. 19, it is understood that the angle at which light is radiated reaches a peak at or around 0 degree in any of red phosphor 45R, green phosphor 45G and scatterer 45B. This shows that blue light BL passes through red phosphor 45R and green phosphor 45G without being absorbed into red phosphor 45R and green phosphor 45G. It is also shown that, in scatterer 45B, blue light BL from light source unit 2 with high directivity exits from scatterer 45B to the outside as it is without being fully scattered in scatterer 45B. In this way, it is understood that, when scattering portion 12 is omitted, a very large part of blue light BL from light source unit 2 passes.

As is clear from FIG. 21, it is also understood that the luminance distributions of red light and green light are smoother than those in the image display device of the comparative example shown in FIG. 19. This shows that blue light BL from light source unit 2 is absorbed favorably into red phosphor 45R and green phosphor 45G.

On the other hand, as is also clear from FIG. 20, with image display device 1 according to the present embodiment shown in FIG. 1, each filter does not show a remarkable peak.

It is therefore understood that scatterer 45B, red phosphor 45R and green phosphor 45G prevent blue light BL from light source unit 2 from passing through scatterer 45B, red phosphor 45R and green phosphor 45G.

The embodiment disclosed herein is illustrative and non-restrictive in every respect. The scope of the present invention is defined by the claims not by the description above, and includes any modification within the meaning and scope equivalent to the claims.

### INDUSTRIAL APPLICABILITY

The present invention is applicable to an image display device and a method for manufacturing an image display device.

### REFERENCE SIGNS LIST

1 image display device; 2 light source unit; 3 light shutter; 4 phosphor substrate; 5 coupling member; 6 substrate; 7 liquid crystal layer; 8 counter substrate; 9 sealing member; 10, 11 polarizing plate; 12 scattering portion; 13, 25, 30 transparent substrate; 14 transistor; 15 gate insulating film; 16 interlayer insulating film; 17 pixel electrode; 18, 27 alignment film; 20 gate electrode; 21 semiconductor layer; 22 drain electrode; 23 source electrode; 26 counter electrode; 31 color filter; 32 phosphor layer; 33 protection film; 34 reflection film; 35, 36, 71, 74, 75 major surface; 37B, 37G, 37R, 83, 86 opening; 40 filter portion; 40B blue filter; 40G green filter; 40R red filter; 41 black matrix; 45B scatterer; 45G green phosphor; 45R red phosphor; 46 barrier wall portion; 47 wall portion body; 50 inner circumferential surface; 51 end surface; 52 outer circumferential surface; 53 end face section; 54 inclined section; 55 flat section; 56, 56a, 56b particulate; 60 air layer; 61a, 61b surface; 62 lower surface; 63 upper surface; 70 mother glass substrate; 72, 73 hole; 76 mother transparent substrate; 77 communicating channel; 78 blocking member; 80 shutter element; 81 reflecting plate; 82 shutter plate; 84, 85 actuator; BL blue light; GL green light; L1, L2 path length.

1. An image display device comprising:
a light source unit emitting light;
a light shutter arranged on said light source unit and selectively causing light received from said light source unit to exit therefrom; and
a phosphor substrate arranged on said light shutter such that light from said light shutter enters and including a phosphor,
said phosphor substrate being arranged such that said phosphor faces said light shutter, and
said phosphor and said light shutter being arranged to face each other with an air layer interposed therebetween.

2. The image display device according to claim 1, wherein said light shutter includes a scattering portion facing said phosphor and scattering light exiting toward said phosphor substrate.

3. The image display device according to claim 2, wherein
said light shutter includes a polarizing plate arranged on the opposite side of said phosphor substrate with respect to said scattering portion, and
said polarizing plate and said scattering portion are formed integrally.

4. The image display device according to claim 2, wherein
said phosphor substrate includes a barrier wall portion formed to surround said phosphor,
said barrier wall portion is formed to protrude toward said light shutter with respect to said phosphor, and
said barrier wall portion is formed to be in contact with said scattering portion.

5. The image display device according to claim 4, wherein
said barrier wall portion includes a wall portion body formed to surround said phosphor and a reflection film formed to cover said wall portion body, and
said reflection film is formed to be in contact with said scattering portion.

6. The image display device according to claim 1, further comprising a coupling member coupling said light shutter and said phosphor substrate, wherein
said coupling member is formed to seal said air layer, and the pressure of said air layer is a negative pressure.

7. The image display device according to claim 1, wherein
said phosphor substrate includes a transparent substrate including a first major surface and a second major surface arranged in a thickness direction, and a color filter formed on the first major surface, of said first major surface and said second major surface, that faces said light shutter,
said color filter includes a plurality of filter portions arranged at a spacing from one another and a light shielding portion formed around said filter portions, and
a spacing between said transparent substrate and said light shutter is smaller than the spacing between said filter portions.

8. The image display device according to claim 1, wherein
said phosphor substrate has formed therein a communicating channel through which said air layer communicates with the outside, and a blocking member is provided at an opening of said communicating channel.

9. An image display device comprising:
a light source unit emitting light;
a light shutter arranged on said light source unit and selectively causing light received from said light source unit to exit therefrom; and
a phosphor substrate arranged on said light shutter such that light from said light shutter enters and including a phosphor,
said phosphor substrate being arranged such that said phosphor faces said light shutter, and
said light shutter including a scattering portion facing said phosphor and scattering light exiting toward said phosphor substrate.

10. A method for manufacturing an image display device, comprising the steps of:
forming a light shutter having an exit surface from which light exits;
forming a phosphor substrate with a phosphor formed therein;
arranging said phosphor substrate on said light shutter such that said exit surface and said phosphor face each other; and
forming a resin layer to seal an air layer between said phosphor substrate and said light shutter.

11. The method for manufacturing an image display device according to claim 10, further comprising the step of sucking air from said air layer to the outside after forming said resin layer.

12. The method for manufacturing an image display device according to claim 10, wherein the step of forming said resin layer is performed in a negative pressure atmosphere.

13. The method for manufacturing an image display device according to claim 10, wherein
said phosphor substrate includes the phosphor and a barrier wall portion formed to surround said phosphor and protruding with respect to said phosphor, and
said resin layer is formed with said phosphor substrate being pressed against said light shutter such that said barrier wall portion and said light shutter are in contact with each other.

14. The method for manufacturing an image display device according to claim 10, wherein
the step of forming said light shutter includes the steps of preparing a transparent substrate, forming a polarizing plate on said transparent substrate, and performing a surface treatment on said polarizing plate to form a scattering portion on a surface of said polarizing plate, and
said phosphor substrate is arranged on said light shutter such that said phosphor and said scattering portion face each other.

15. The method for manufacturing an image display device according to claim 10, wherein
the step of forming said light shutter includes the steps of preparing a transparent substrate, forming a polarizing plate on said transparent substrate, and performing a coating treatment on said polarizing plate to form a scattering portion, and
said phosphor substrate is arranged on said light shutter such that said phosphor and said scattering portion face each other.
